(19) United States
(12) Patent Application Publication
(10) Pub. No.: US 2005/0108336 A1
(43) Pub. Date: May 19, 2005

(54) Optional receipt of an email attachment

(75) Inventors: Indran Naick, Cedar Park, TX (US); Jeffrey Kenneth Wilson, Austin, TX (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 10/713,736

(22) Filed: Nov. 13, 2003

(51) Int. Cl. G06F 15/16

(52) U.S. Cl. 709/206; 709/218

(57) ABSTRACT

Methods, devices, systems, and media are disclosed for selective receipt of an e-mail attachment. One embodiment includes receiving an instruction from a sender to add a selectable notification of an email attachment to a first email. Further, the embodiment includes inserting code in the first email to transmit a reply to the sender upon execution of the code by an email client, wherein execution is responsive to activation of the selectable notification by a recipient. Further still, the embodiment includes generating a second email having the email attachment upon receipt of the reply, and transmitting the second email to the recipient in response to the reply.

### CROSS-REFERENCES TO RELATED APPLICATIONS

Pursuant to 35 USC §119(e), this application claims priority to and benefit of U.S. patent application Ser. No. ______, entitled “PRIVATE EMAIL CONTENT”, attorney docket number AUS920030777US1, filed on the same day, the disclosure of which is incorporated herein in its entirety for all purposes.

Pursuant to 35 USC §119(e), this application claims priority to and benefit of U.S. patent application Ser. No. ______, entitled “SELECTIVE TRANSMISSION OF AN EMAIL ATTACHMENT”, attorney docket number AUS920030775US1, filed on the same day, the disclosure of which is incorporated herein in its entirety for all purposes.

### FIELD OF INVENTION

The invention generally relates to optional receipt of an email attachment. More particularly, the invention relates to methods, devices, systems, and media for adding a selectable notification of an email attachment, associated with code into an email, which, when activated by the recipient, retrieves the email attachment from the sender of the email.

### BACKGROUND

Electronic mail (“email”) is an electronic message, which a user types at a computer system, and then transmits over a computer network to another user. For a user to type an email, the computer system includes an email client (“client”), which is an application used to read, write and send email. In simple terms, the client is the user interface for an electronic messaging system.

Typically, the email client includes a simple text editor, an address book, a filing cabinet and a communications module. The text editor allows the user to compose a text message for an email, and usually includes spell and grammar checking as well as formatting facilities. The text editor may also include the ability to append attachments to an email such as files, documents, executable programs, schematics, etc. The address book stores commonly used email addresses in a convenient format to reduce the chance of email address errors. The filing cabinet stores email messages, both sent and received, and usually includes a search function for easy retrieval of a desired email or email attachment. The communications module deals with transport to and from the email client over a computer network to a mail server, the application that receives an email from email clients and/or other mail servers.

An organization's computer network consists of a number of computer systems interconnected with links for transmission of data between the computer systems, which serve as conduits to send an email to a recipient. In addition to handling email traffic, with or without email attachments, it is noteworthy to point out that these computer systems also handle the everyday rigors of an organization's use, including, for example, storing and retrieving documents, running multiple applications and operating systems, and so forth. The physical design of each link limits the bandwidth for the link. Bandwidth refers to the amount of data that can be transmitted in a fixed amount of time. The topology of the network, i.e., the organization, number, and interconnection between links of the network, can be designed to increase bandwidth between different points on the network by providing parallel links. Therefore, design of the bandwidth and topology for these networks must take into consideration all traffic, finding a balance between the costs involved with increasing bandwidths of links and the slow downs when the bandwidths are less than the peak traffic requirements.

Compromising the network's capacity more so is the handling of email traffic when the emails include email attachments. Email attachments can cause the traffic bandwidth requirements to peak, slowing down the network for everyday operations. For example, a user may draft a text email, which is about 20 kilobytes, and transmit the email to ten people. As a result, the mail server introduces 200 kilobytes of data to the network when the mail server generates a copy of the email for each of the ten recipients. Even small networks are likely able handle 200 kilobytes without any noticeable slow downs. However, the user may decide to transmit a drawing, which may be somewhere between 2 megabytes and 20 megabytes, along with the text of the email to enhance the communication. Now, the mail server copies not only the email, but also the email attachment and introduces between 22 megabytes and 202 megabytes of data traffic at substantially the same time, peaking the load, at least in certain links, of even large networks. This makes the network run slower for other users. More troublesome, however, is that many times, emails are sent with email attachments to multiple recipients and many of these recipients may not need or even want the email attachments.

Some solutions attempt to alleviate email traffic congestion by “throwing more money at the problem.” That is, to solve the congestion problem by increasing the size of the network by increasing the network's bandwidth. In order to display, store, and retrieve data, the network must have computer systems such as dedicated mail servers of sufficient size to accommodate the data traffic requirements. Therefore, increasing a network's bandwidth necessarily requires an organization to make greater expenditures or institute restrictions on use of the network's computer systems to keep pace with the increased demands.

Further, the purchase of additional hardware components necessarily increases the mail server administrator's involvement in handling the ever-increasing email traffic over an organization's network, resulting in greater administrative costs. These types of solutions, however, are piecemeal solutions that will forever require greater expenditures or restrictions as an organization grows. In short, these solutions are not solutions; they are patches for network problems.

It is apparent that there is a need for devices, methods, systems, and media for optional receipt of email attachments that overcomes these problems, and specifically attenuates or eliminates the needs for increasing a network's size and administration, and instituting restrictions on network use by reducing or at least time-shifting transmission of email attachments.

### SUMMARY OF THE INVENTION

Embodiments of the invention generally provide methods, systems, and media for selectively transmitting an e-mail attachment. In one embodiment, the method generally includes receiving an instruction from a sender to add a selectable notification of an email attachment to a first email. Further, the method includes inserting code in the first email to transmit a reply to the sender upon execution of the code by an email client, wherein execution is responsive to activation of the selectable notification by a recipient. Further still, the method includes generating a second email having the email attachment upon receipt of the reply, and transmitting the second email to the recipient in response to the reply.

In another embodiment, the invention provides a device for selective transmission of an e-mail attachment. The device generally includes a notification incorporator to add a selectable notification of an email attachment to a first email in response to an instruction from a sender. Further, the device includes a code associator to insert code in the first email to transmit a reply to the sender upon execution of the code by an email client and to associate execution of the code with activation of the selectable notification by the recipient. Further still, the device includes an attachment responder to generate a second email having the email attachment upon receipt of the reply and to transmit the second email to the recipient in response to the reply.

In yet another embodiment, the invention provides a machine-accessible medium containing instructions for selectively transmitting an e-mail attachment, which when executed by a machine, cause the machine to perform operations. The instructions generally include operations for receiving an instruction from a sender to add a selectable notification of an email attachment to a first email. Further, the instructions include operations for inserting code in the first email to transmit a reply to the sender upon execution of the code by an email client, wherein execution is responsive to activation of the selectable notification by a recipient. Further still, the instructions includes operations for generating a second email having the email attachment upon receipt of the reply, and transmitting the second email to the recipient in response to the reply.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a system for selective receipt of an email attachment in accordance with the disclosed invention.

FIG. 2 depicts an example embodiment of a device for selective receipt of an email attachment in accordance with the disclosed invention.

FIG. 3 depicts an example embodiment of a method for selective receipt of an email attachment in accordance with the disclosed invention.

### DETAILED DESCRIPTION OF THE EMBODIMENTS

The following is a detailed description of example embodiments of the invention depicted in the accompanying drawings. The embodiments are examples and are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, systems, devices, methods, and media for selective receipt of an email attachment are contemplated. Embodiments include a computer system having an email client, a front-end software application that enables a sender to generate and transmit emails across a network to one or more recipients. The email client may also include functionality to allow the sender to generate an email for multiple recipients with one or more attachments and to select the recipients that will have the option to receive one or more of the email attachments. In response to identifying the recipients that will have the option to receive the email attachments, the email client may insert a selectable notification into the email, having code that facilitates retrieval of the email attachments from the sender by the recipients. For example, the sender may send an email with a selectable notification to a recipient, Joe utilizing a computer system having an email client. Joe receives the email, decides that he wants to review the attachment and clicks on the selectable notification. In some fully automated embodiments, a reply to the email is sent back to the sender, the reply initiates code within the email client that generates a second email in response to the reply, attaches the email attachment(s) associated with the selectable notification, and transmits the second email to Joe. In further embodiments, the sender may include a prompt in the code associated with the selectable notification to allow Joe to attach comments to the reply. In many embodiments, the sender may also activate a prompter in the email client to prompt the sender when Joe requests the email attachment so the sender may approve transmission of the email attachment to Joe, locate the email attachment to append to the second email, and/or add comments to return to Joe in the second email along with the email attachment.

Advantageously, embodiments of the present invention reduce or attenuate instantaneous data traffic on a network by time-shifting the transmission of email attachment to those recipients that opt to receive the email attachments and eliminating the additional data traffic associated with transmitting email attachments to recipients that do not want to receive them. Further, embodiments may be implemented in a single email client, i.e., client-side, without requiring installation of software or additional hardware in a mail server by an administrator.

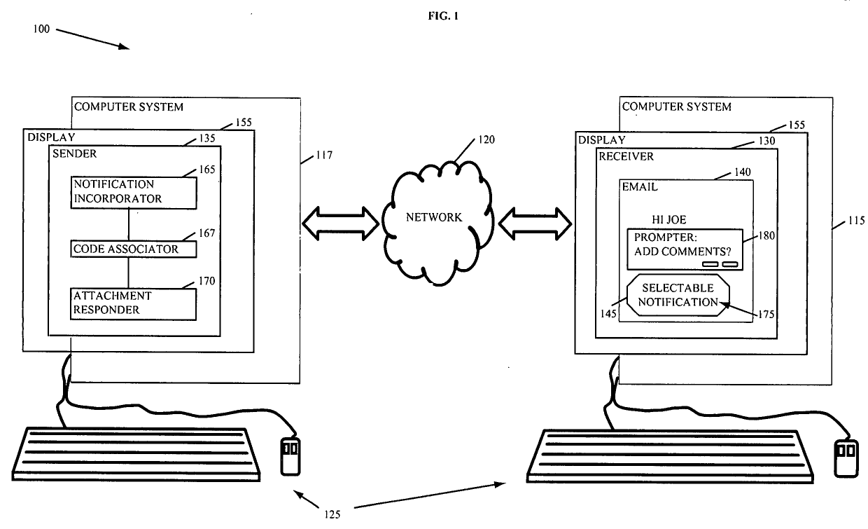

Turning now to the drawings, FIG. 1 depicts an embodiment of a system 100 for selective receipt of an email attachment 105 by a receiver 110. For clarity and easy of discussion, rather than showing actual receipt of the email attachment 105 by a receiver 130, FIG. 1 depicts the system 100 in terms of the overall transmission for the system 100.

FIG. 1 depicts two computer systems 115, 117 in communication with one another through a network 120. Each of the two computer systems 115, 117 may be stand-alone computer systems or part of the same or a different network 120. In regard to the computer systems 115, 117, each normally includes peripherals 125, such as a keyboard and a mouse, as well as non-enumerated components including a microprocessor, memory, printer, CD-ROM device, and a modem to connect to a computer system 115 to another computer system 117 over a network 120.

Typically, each computer system 115, 117 further includes an email client (“client), for the user to compose, send and receive email over the network 120. For clarity and ease of discussion, as will become apparent later, FIG. 1 shows computer system 115 having an email client, collectively denominated as receiver 130, and computer system 117 having an email client, collectively denominated as sender 135. The client, itself, is a software application, such as Outlook Express™, Netscape Messenger™, Microsoft Outlook™, Entourage X™, and Eudora™. The client usually includes an intuitive, graphical user interface (“GUI”) and a simple text editor that allows the user to create an email 140 by opening a new message window and typing a text message via peripherals 125 associated with the respective computer systems 115, 117. In addition, the client usually includes simple spell checking and formatting facilities, as well as facilities to attach and detach documents, diagrams, executables, and so on (collectively, “email attachments”) to an email 140. For example, in the system 100, sender 135 generates email 140 to send to receiver 130. To generate email 140, a user of computer system 117 types in email 140 and transmits email 140 to computer system 115 via network 120. After generating the message “Hi Joe” in email 140, the user instructs sender 135 to add a selectable notification 145 to the email 140 before sending the email 140 to the receiver 130.

Notification incorporator 165 responds by inserting selectable notification 145 into the body of email 140. Selectable notification 145 may include text, a hyperlink, hypertext, an icon, or the like. In many embodiments, notification incorporator 165 may request preferences of the user of sender 135. In particular, notification incorporator 165 may ask the user whether to completely automate the process of responding to a request for an attachment from receiver 130 and/or other recipients, or to prompt the user via sender 135 for approval. In some embodiments, the user may also select a preference to be prompted to select an email attachment to return to receiver 130 if receiver 130 requests the attachment. Such prompting is advantageous since a newer version of the email attachment may be available at the time the recipient requests the email attachment.

Briefly before discussing the adding of the selectable notification 145 to the email 140, it is worthwhile to have a general understanding of the selectable notification 145. The selectable notification 145 is a set of user-defined rules or macro, enabled by software and/or hardware located on the email client's computer system 115, 117, for permitting a receiver 130 of an email 140 to optionally receive an associated email attachment. Further, the selectable notification 145, again enabled by software and/or hardware, takes the form of an icon or other symbolic link that is selectable by receiver 130 by clicking on or otherwise choosing the selectable notification 145 with the peripherals 125 in communication with the receiver 130. For example, receiver 130 may move a cursor 175 over selectable notification 145 and click a mouse button or press a key on a keyboard to activate the selectable notification 145.

Returning to the adding of the selectable notification 145, the sender 135 follows one of the user-defined rules, to add the selectable notification 145 to the email 140. For example, the sender 135 may include one field for entering the intended receivers for the email 140 and the email attachment, and another field for entering the intended receivers for the email 140 with the selectable notification 145 in place of the email attachment. In another example, the sender 135 may include only one field, wherein all entered receivers are intended to receive the email 140 with the selectable notification 145. The email 140 with the selectable notification 145 is then forwarded to the receiver 130 over a network 120 that is in communication with both the sender 135 and the receiver 130.

The system 100 shows the receiver 130 receiving the email 140 with the selectable notification 145, which is viewable by the use of a display 155, such as a monitor, in communication with the receiver 130. Receiver 130 may click on or otherwise choose the selectable notification 145 to generate a request 160 containing the selectable notification 145 for sender 135 to transmit the email attachment associated with the email 140.

Upon activating selectable notification 145, code associated with selectable notification 145 such as hypertext markup language (HTML), extensible markup language (XML), or other programming language compatible with receiver 130, may prompt receiver 130 via prompt window 180 to add content to a reply that requests the email attachment from sender 135. For instance, receiver 130 may add comments in the form of text or symbols to the reply. In some embodiment, receiver 130 may even attach files. Receiver 130 may, for example, enter a comment requesting that sender 135 include the latest version of the document which is the email attachment associated with selectable notification 145.

In other words, when receiver 130 activates selectable notification 145, receiver 130 elects to send a reply to sender 135 for the email attachment associated with selectable notification 145, likely located in storage on the sender's 135 computer system 117. Then, code associated with selectable notification 145 is executed by receiver 130, opening a new email message window, addressing the new message to sender 130, and, in some embodiments, inserting a text message to communicate to sender 135 that receiver 130 wants to receive the email attachment.

When sender 135 receives the reply, sender 135 processes the reply either automatically or by responding to prompts, based upon preferences stored by sender 135 for selectable notification 145. More specifically, when generating the first email 140 that included the selectable notification 145, the sender 135 may decide whether sender 135 will be prompted when receiver 130 requests the email attachment or if retrieval of the email attachment will be invisible to sender 130.

By capturing or pre-programming the address of recipients such as receiver 130 in computer system 117 prior to transmitting the first email 140 without the attachment, then authenticity of the receiver 130 is verified should receiver 130 make a request 160 for the email attachment.

Sender 135 further includes an attachment responder 170 for attaching the requested email attachment. Attachment responder 170, enabled by software and/or hardware located on sender's 135 computer system 117, fetches the requested email attachment from storage likely located within sender's 135 computer system 117, for sending to the receiver 130. As an alternative, the system 100 may rely on conventional use of a peripheral 125 on the sender 135 to attach the requested email attachment in order to send the requested email attachment to the receiver 130. For example, upon receipt of a reply from receiver 130, attachment responder 170 may prompt sender 130 to locate the email attachment to send to receiver 130 by displaying a window having, e.g., the contents of a current directory of a hard drive in or attached to computer system 117. Sender 130 may then select the email attachment from that directory or navigate directories and/or drives to select the email attachment.

In addition and prior to sending the second email in response the reply to the first email, sender 135 may implement a prompter similar to prompter 180 to request that sender 135 include a text message with the second email.

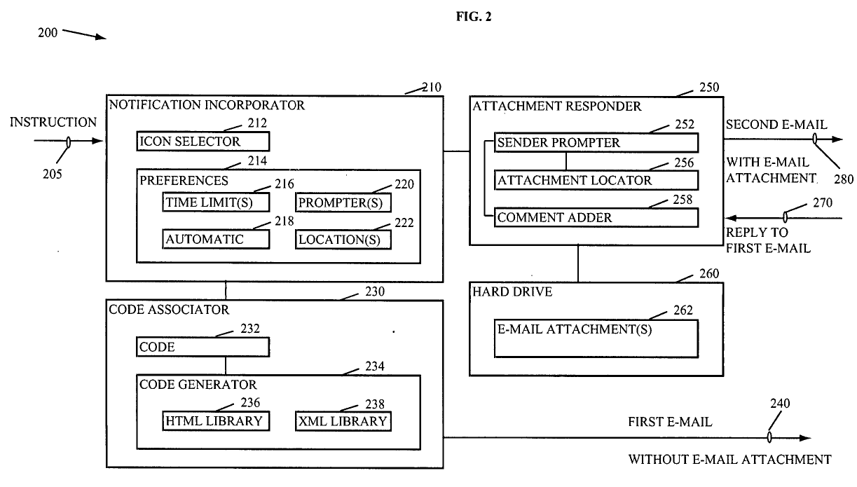

Turning now to FIG. 2, an example embodiment of a device 200 for optional receipt of an email attachment is disclosed. Device 200 may be part of an email client for a user that intends to send an email that offers optional receipt of the associated email attachment(s) such as sender 135 described in conjunction with FIG. 1 and may be capable of sending and receiving email. Device 200 may include a notification incorporator 210, a code associator 230, an attachment responder 250, and a hard drive 260.

Notification incorporator 210 may recognize a command or instruction from a sender to affirmatively include the option of retrieving an email attachment 262, or an instruction to exclude one or more email recipients of multiple recipients targeted by the email, from receiving the email attachment(s) 262. For example, a sender may compose a first email 240 and address it to several recipients. The user may attach one or more email attachments 262 but select less than all of the recipients of the first email 240 to receive the email attachments 262. Notification incorporator 210 recognizes that some of the recipients are designated not to receive one or more of the email attachments so notification incorporator 210 may prompt the sender to determine whether one or more of the recipients should receive a selectable notification to allow those recipients to optionally retrieve the email attachments 262. In other embodiments, notification incorporator 210 may automatically add the option for all the recipients or categories of recipients such as recipients in the “TO” header of the first email 240.

Notification incorporator 210 may include an icon selector 212 and preferences 214 and may couple with code associator 230 to associate code with the selectable notification to provide the recipient with the option to retrieve an email attachment. Icon associator 212 associates a symbol with code as the selectable notification so the user may click on the icon to activate or execute the code. For example, icon associator 212 may allow the sender to select an icon such as a paperclip. Then, if the recipient engages to icon, the recipient's email client executes the code, generating a reply 270 email that requests the email attachment(s) 262 from the sender.

Preferences 214 include optional methods of implementing this embodiment. For instance, time limit(s) 216 allows the sender to select a time limit for the activation of the selectable notification to retrieve one or more email attachments 262. Automatic 218 allows the sender to automate approval to return email attachment 262 in response to reply 270 from a recipient. In many embodiments, at least some recipient authentication is performed but in many of these embodiments, retrieval of the email attachment 262 by the recipient may be substantially transparent to the sender. If the response is not set to automatic for one or more recipients, the sender will be prompted upon receipt of a reply 270 from one of those recipients, requesting that the sender approve retrieval of the email attachment 262.

Prompter(s) 220 may allow the sender to decide whether the code associated with the selectable notification should prompt the recipient, e.g., before sending the reply 270 to ask if the recipient wants to include comments in the reply 270. Prompters 220 may also include preferences for the sender. For example, the sender may indicate that the sender should be prompted to include a comment along with the email attachment 262 in the second email, which includes the email attachment.

Location(s) 222 includes preferences selectable by the sender and related to the location of the email attachments 262. The sender may choose, for instance, to point out the location of the attachments 262 when composing the first email 240 and the use that email attachment 262 at that location as the email attachment 262 optionally retrieved by the recipient. On the other hand, the sender may include a preference indicating that the sender should be prompted prior to attaching the email attachment 262 to the second email 280 so that sender may either override a default selection of the email attachment 262 or select a file as the email attachment. Advantageously, if a recipient is unable to review the attachment 262 immediately upon receipt of the first email 240, the recipient can use the selectable notification when ready to review the email attachment 262 and the sender can make sure that the recipient actually receives the latest version of the email attachment 262.

Code associator 230 inserts or adds code to the first email 240 and associates the code with the icon or text representing the selectable notification. For example, the code may 20 include instructions for an email client in JAVA™, extensible markup language (XML), or hypertext markup language (HTML). In some embodiments, typical or default code may be included in standard code 232 so code associator 230 may copy the code, associate the code with the selectable notification and store the code in the email. In other embodiments, when the preferences selected differ from functionality included in standard code 232, code generator 234 may selectively add code modules together from code module libraries such as HTML library 236 or XML library 238, to generate code that functions as the sender has indicated. The code modules, for instance, may be designed to implement functions related to each preference available in preferences 214.

Once the selectable notification is added and associated with code, the first email 240 may be sent to one or more recipients without the email attachment. A recipient may receive the first email 240 and press the selectable notification upon deciding to retrieve the email attachment 262. Activation of the selectable notification executes code in the first email 240 that causes the recipients email client to open a new email as a reply 270 for the sender. Then, depending upon the preferences selected by the sender via notification incorporator 210, the code may, e.g., prompt the recipients to add comments to the reply 270, add text indicating that this recipient requests the email attachment(s) 262, and then transmit the reply 270 to the sender.

Attachment responder 250 may receive the reply 270, generate a second email 280 in response to the reply 270, attach email attachment 262 to the second email 280 and transmit a second email 280 to the recipient. Attachment responder 250 may include sender prompter 252, attachment locator 256, and comment adder 258. Sender prompter 252 may prompt the sender to approve the return of email attachment 262 with second email 280 to the recipient and/or request that the sender add comments to second email 280 for the recipient prior to sending second email 280, depending upon the sender's preferences 214.

Attachment locator 256 may prompt the sender to provide the location of email attachment 262 on hard drive 260 and/or verify the location of email attachment 262. In many embodiments, a prompt for approval to send the email attachment 262 to the sender is combined with the prompt to locate the email attachment 262 to return to the recipient.

Comments adder 258 facilitates the addition of comments to the recipient when the recipient opts to receive email attachment 262. For instance, the sender may say that email attachment 262 is in the process of being updated, that email attachment 262 is the latest version, or other pertinent or non-pertinent message.

In further embodiments, once attachment responder 250 has responded to a recipient, attachment responder 250 may not respond to additional activations of the selectable notification in the first email 240. Advantageously, such an arrangement may reduce data security issues. On the other hand, a group of persons on a project may need to have the latest revision of a document produced by the sender. The sender may send the first email 240 with or without the document as an email attachment 262 but include a selectable notification. The sender may then allow these persons to repeated use the selectable notification to automatically retrieve the email attachment 262 so they can update their version of the email attachment 262 whenever they work with it.

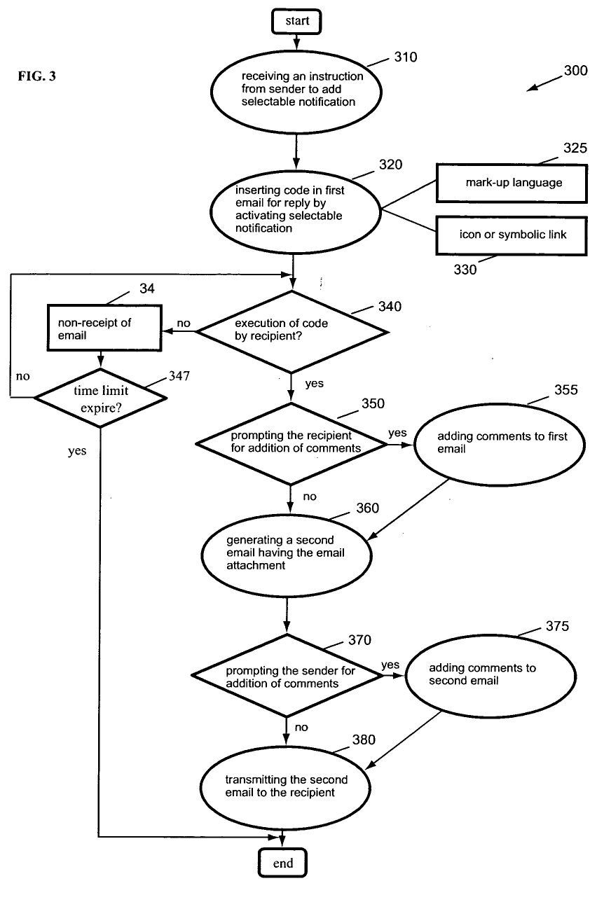

Turning now to FIG. 3, another aspect of the invention is disclosed. In particular, an embodiment of a flowchart 300 for selectively transmitting an e-mail attachment is disclosed. Flowchart 300 is for a device, such as device 200 shown in FIG. 2, wherein a sender transmits an email with a selectable notification of an e-mail attachment. By execution of the selectable notification, either automatically by e-mail clients or manually by users of the e-mail clients, the receiver of the e-mail receives the e-mail attachment.

Flowchart 300 begins by receiving 310 an instruction from a sender to add a selectable notification of an email attachment to a first email. Before discussing the receiving 310, it is helpful to first understand the computer systems. The sender is denominated as the sender because it includes a computer system having an e-mail client that sends an email, that is, the first email, to another computer system with an e-mail client, i.e., the receiver. In addition to having email clients located on both the receiver and the sender, the receiver's and sender's computer systems also include, for example, a keyboard, mouse, display (e.g., monitor), microprocessor, memory, printer, CD-ROM device, and a modem, and other peripherals and components.

Returning to the receiving 310, the flowchart 300 shows receiving 310 an instruction from the sender to add a selectable notification to a first email. The sender generates an email with email attachment(s) to one or multiple recipients, and determines whether all or some of the email recipients are to receive the email attachment(s) accompanying the email. For recipient(s) not receiving the email attachment(s), the sender permits entry of an instruction, enabled by software and/or hardware on the sender, to add a selectable notification to the first email before sending the email to the recipient(s) to receive the email with the selectable notification instead of the email attachment. Sending recipients emails in this fashion, that is, with the selectable notification instead of the email attachment(s), decreases valuable bandwidth consumption caused by sending emails with email attachments that at least some of the recipients may not want.

The selectable notification included by the sender is a set of user-defined rules or macro, enabled by software and/or hardware, that visually serves as a indicator that the received email has an one or more available email attachment(s) that the particular receiver did not receive with a received email. The selectable notification, again enabled by software and/or hardware, takes the form of an icon or other symbolic link that is selectable, by clicking or otherwise choosing, the selectable notification with the peripherals in communication with the receiver or sender.

The flowchart 300 continues by inserting 320 code in the first email to transmit a reply to the sender upon execution of the code by an email client. Upon receipt of the first email by the receiver, the receiver determines whether or not to receive the email attachments that the selectable notification indicates is available upon request. In order for the receiver to have the availability to request the email attachment(s) from the sender, code is inserted 320 into the selectable notification before the first email is sent to the receiver. This inserting 320 of code, such as mark-up language 325 or an icon 330, provides functionality for the receiver to reply to the sender with a request to send the available email attachment(s) by activating the selectable notification, which executes the code embedded in the selectable notification.

At this point, the receiver decides whether to execute the selectable notification 340 by, for example, clicking on the selectable notification found in the first email, to transmit a reply to the sender. Whether to execute the selectable notification depends on whether the receiver wishes to receive the email attachments or if later retrieval is preferable. If the receiver decides not to activate the selectable notification, the receiver does not receive the available email attachments 345. Deciding not to receive the available email attachments is a classic example of conservation of bandwidth that would have been wasted if the receiver had received the unwanted email attachments. As another example of conserving bandwidth, the receiver may decide to receive the email attachment(s), but to request the email attachments at a later time when bandwidth consumption is not at peak intervals. That is, to time-shift the request for the email attachment, say, possibly at nighttime, so as not to infringe on valuable bandwidth a company's network may need during daytime hours. If a time limit imposed by the sender for retrieving the email attachment has not expired 347, then the recipient may retrieve it.

If the receiver decides to execute the code 340 embedded in the selectable notification, and, thereby, request the email attachment(s), then the flowchart 300 depicts a further embodiment of optionally prompting 350 the receiver for additional textual comments before sending the reply to the sender. In order to prompt, software (i.e., code) and/or hardware provides the selectable notification with the prompting 350 functionality before the first email is sent to the receiver. If prompting 350 the recipient occurs, then the recipient may add 355 comments to accompany the reply for transmission to the sender.

The flowchart 300 continues by generating 360 a second email including the requested email attachment(s) upon receipt of the reply. Further software (i.e., code) and/or hardware found within the selectable notification, which the sender included in the first email and the receiver activated, enables generation and sending of the second email. For generating 360 the second email, the selectable notification may include further code to enable searching, finding, and attaching the requested email attachment(s) that the sender indicated were available by the first email's inclusion of the selectable notification. On the other hand, in generating 360 the second email, the selectable notification may require the sender to attach the requested email attachment(s), by, for example, through use of an attaching functionality found on available e-mail clients such as Outlook™ and Eudora™.

Prior to transmitting 380 the email attachment(s) to the recipient, the flowchart 300 depicts a further embodiment of optionally prompting 350 the sender for additional textual comments before sending the email attachment(s) to the sender. Like prompting 350 of the recipient, prompting 350 the sender occurs through software (i.e., code) and/or hardware inserted into the selectable notification. If prompting 370 the sender occurs, then the sender may add 375 comments to accompany the email attachment(s) to be transmitted to the sender.

The flowchart culminates in transmitting 380 the second email, having the requested email attachments and optional comments, to the receiver. Again, this transmitting 380 occurs by more code inserted into the selectable notification. That is, receiving 310 the instruction from the sender to add the selectable notification is an instruction to add a selectable notification containing code to enable the functionality of flowchart 300. As a result, the selectable notification, as shown by the flowchart 300, provides a client-sided solution to a bandwidth consumption problem that, by the nature of the solution, does not require the assistance of a mail server administrator, or the purchase of additional and expensive mail server software or hardware, such as storage for the available email attachments already on the sender's hard drive.

After transmitting 380 the email attachment(s), a receiver receiving the email attachments may detach the email attachment(s) from the second email for download or display on a computer system in communication with the receiver.

Another embodiment of the invention is implemented as a program product for use with a computer system such as, for example, the system 100 shown in FIG. 1. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

While the foregoing is directed to example embodiments of the disclosed invention, other and further embodiments of the invention may be devised without departing from the basic scope thereof, and the scope thereof is determined by the claims that follow.

1. A method for selectively transmitting an email attachment, the method comprising:
receiving an instruction from a sender to add a selectable notification of an email attachment to a first email;
inserting code in the first email to transmit a reply to the sender upon execution of the code by an email client, wherein execution is responsive to activation of the selectable notification by a recipient;
generating a second email having the email attachment upon receipt of the reply; and
transmitting the second email to the recipient in response to the reply.

2. The method of claim 1, further comprising prompting the recipient prior to transmission of the reply to the sender.

3. The method of claim 2, wherein prompting the recipient comprises requesting the recipient add comments for the sender to the reply.

4. The method of claim 1, further comprising prompting the sender prior to transmission of the second email to the recipient.

5. The method of claim 4, wherein prompting the sender comprises requesting the sender to locate the email attachment to transmit the second email to the recipient.

6. The method of claim 4, wherein prompting the sender comprises requesting the sender add comments for the recipient to the second email.

7. The method of claim 1, wherein receiving the instruction comprises receiving the instruction to exclude the email attachment from the first email.

8. The method of claim 1, wherein inserting code in the first email comprises inserting a markup language.

9. The method of claim 1, wherein inserting code in the first email comprises inserting an icon and linking the code to the icon.

10. A device for selective transmission of an e-mail attachment by a recipient, the device comprising:
a notification incorporator to add a selectable notification of an email attachment to a first email in response to an instruction from a sender;
a code associator to insert code in the first email to transmit a reply to the sender upon execution of the code by an email client and to associate execution of the code with activation of the selectable notification by the recipient; and
an attachment responder to generate a second email having the email attachment upon receipt of the reply and to transmit the second email to the recipient in response to the reply.

11. The device of claim 10, wherein the code associator inserts code comprising at least one prompter, wherein the at least one prompter permits optional entry of text in the reply.

12. The device of claim 10, wherein the attachment responder comprises at least one prompter, wherein the prompter permits optional entry of text in the second email.

13. The device of claim 10, wherein the attachment responder comprises at least one prompter, wherein the prompter requests the sender to locate the email attachment.

14. The device of claim 10, wherein the notification incorporator is responsive to the instruction, wherein the instruction excludes the email attachment from the first email.

15. The device of claim 10, wherein the code associator inserts code comprising a markup language.

16. The device of claim 10, wherein the code associator inserts an icon and associates the icon with the code.

17. A machine-accessible medium containing instructions, which when executed by a machine, cause the machine to perform operations for selective transmission of an e-mail attachment, comprising:
receiving an instruction from a sender to add a selectable notification of an email attachment to a first email;
inserting code in the first email to transmit a reply to the sender upon execution of the code by an email client, wherein execution is responsive to activation of the selectable notification by a recipient;
generating a second email having the email attachment upon receipt of the reply; and
transmitting the second email to the recipient in response to the reply.

18. The machine-accessible medium of claim 17, wherein the operations further comprise instructions for prompting the recipient prior to transmission of the reply to the sender.

19. The machine-accessible medium of claim 17, wherein the operations further comprise instructions for prompting the sender prior to transmission of the second email to the recipient.

20. The machine-accessible medium of claim 20, wherein prompting the sender comprises requesting the sender to locate the email attachment to transmit the second email to the recipient.
